(19) United States
(12) Patent Application Publication
(10) Pub. No.: US 2010/0258587 A1
(43) Pub. Date: Oct. 14, 2010

(54) Windshield Washer Fluid Dispenser

(76) Inventors: Loyde A. Wheeler, Spokane, WA (US); David A. Wheeler, Spokane, WA (US); Cynthia M. Wheeler, Spokane, WA (US)

Correspondence Address: K&L Gates LLP, 618 W. Riverside, Suite 300, SPOKANE, WA, 99201-0628, US

(21) Appl. No.: 12/758,737

(22) Filed: Apr. 12, 2010

Related U.S. Application Data
(60) Provisional application No. 61/168,896, filed on Apr. 13, 2009.

(51) Int. Cl. B67D 7/10; B65B 3/04; B67D 7/30; B67D 7/16

(52) U.S. Cl. 222/2; 222/1; 141/18; 222/14; 222/71; 222/74

(57) ABSTRACT

A windshield washer fluid dispenser providing a delayed start function, whereby the user can open the hood of their vehicle and cap to their fluid reservoir. A windshield washer fluid dispenser utilizing a cellular credit card processing system for payment means, whereby the processing system is configurable for a given application. Embodiments with proximity device, RFID and wireless telephone verification are included. A windshield washer fluid dispenser having a ready light, a warning light, a start button, a flow meter and a programmable logic circuit. A windshield washer fluid dispenser system providing for a replaceable fluid drum. Methods pertaining to the disclosed apparatus are also provided.

### CROSS REFERENCE TO RELATED APPLICATIONS

This application claims the benefit of U.S. Provisional Application No. 61/168,896, filed Apr. 13, 2009, and whose entire contents are hereby incorporated by reference.

### BACKGROUND

Vehicles including cars, trucks, motor homes and the like typically have reservoirs and pumps that can be selectively activated to spray windshield washer fluid on the vehicle windshield. Such windshield washer fluid, in conjunction with the vehicle windshield wipers, cleans or otherwise removes undesirable dirt, bugs or other matter from the outer surface of the windshield.

Vehicle windshield washer fluid reservoirs vary in shape and size, but typically will hold a supply of at least a quart of water or windshield washer fluid. The windshield washer fluid supply will diminish with use and the vehicle operator often finds that the fluid has been totally depleted at an inappropriate time.

Under these circumstances an operator usually makes a special trip to a retail outlet where the windshield washer fluid is sold and purchases a one-gallon container of windshield washer fluid. Since the amount of fluid in these containers is typically more than the vehicle windshield washer fluid reservoir will hold, after filling the reservoir the operator will either dispose of the surplus windshield washer fluid or temporarily store the surplus fluid in its open container in the trunk or other storage area of the vehicle. It is not uncommon, given the latter event, that the container works itself open after a period of time, spilling the surplus windshield washer fluid in the vehicle.

At a later date, when the supply of windshield washer fluid in the vehicle windshield washer fluid reservoir is again depleted, the vehicle user must then either use the surplus fluid from the previous purchase (if available) or buy more windshield washer fluid. In the former event, there may not be enough surplus fluid to fill the vehicle windshield washer fluid reservoir a second time. In the latter event, the user is now saddled with two containers.

It is unusual that a full windshield washer fluid reservoir will become fully depleted between vehicle fuel fillings. Thus, if the vehicle operator had access to windshield washer fluid each time the vehicle refueled, the vehicle windshield washer fluid reservoir would not likely become depleted at an inappropriate time.

Various prior art in the area has provided a partial solution to these problems, including the inventors' own U.S. Pat. No. 6,910,509, which is hereby incorporated by reference. However, several limitations and shortcomings have been evidenced in the prior art. For example, many embodiments of the prior art contain non-removable storage containers or drums, restricting the ability to simply swap a fully charged container of windshield washer fluid, rather than refill the existing permanent container. Other prior art embodiments do not confer the advantages of new wireless technologies or programmed logic circuits.

Further, many prior art embodiments to not exhibit further refinements on the ergonomic and consumer-friendly aspects that the present inventors have developed. For example, in most prior art embodiments, once payment is tendered, the pump of the windshield washer immediately commences for a timed period. However, as is the case with many other vending machines, at times the consumer is not necessarily ready for the timer/pump combination to commence. By way of example, what if a consumer deposits their coins and the pump begins, only to realize that their hood is still shut and locked, and the cap to the windshield washer fluid is not yet removed? The time expended to return to the driver's compartment, find the hood release, raise the hood, find the windshield washer fluid container and remove the cap, can end up costing a consumer half or more of their time allotted for pumping the fluid. This scenario results in a less favorable or negative experience for the consumer, and ultimately results in reduced revenues.

What is needed in the marketplace is a windshield washer fluid dispenser that provides an environmentally safe and convenient alternative to the standard washer fluid “jug”. With each use of such an advanced dispenser, one plastic “jug” of washer fluid can be saved from the recyclers or landfills of the Earth. A need has therefore been evidenced for a windshield washer fluid dispenser that can be associated with a fuel filling station or other convenient location where a vehicle is regularly maintained or kept—which improves the embodiments evidenced by the prior art. The present invention fills this need, as will be understood from the following description and accompanying drawings.

### SUMMARY

In one aspect, embodiments of the present invention provide for a removable container to store the windshield washer fluid. Among other possible benefits, this provides for ease of re-filling of the vending machine.

In another aspect, embodiments of the present invention provide a programmable logic circuit capable of delivering enhanced features to a customer, together with more intelligent tracking of operation of the machine. Such a programmable logic circuit is further preferably coupled with a wireless connection to a network for interoperation with other control devices. Such control devices can comprise, by way of example, a wireless credit card device capable of independently providing payment and effecting a transaction without traditional hardwired electronic connection (e.g. a telephone line or other wired connection).

In yet another aspect, embodiments of the present invention evidence a “Start” button capable of delaying the commencement of the timing mechanism and pump. This provides ample time for a consumer to complete their transaction in due course and enjoy the full time of the timer/pump without hurrying to unlock the hood, raise the hood and remove the windshield washer cap.

In still yet another aspect, embodiments of the present invention evidence a unique compressed air, water line or vacuum mechanism to pump the windshield washer fluid from its internal storage container to the consumer's vehicle.

Finally, additional improvements to the ergonomics and function of the windshield washer fluid dispenser are provided in embodiments disclosed herein, including improvements in control and lighting of the device.

In preferred embodiments, a customer experience in rendered such that the customer has played an immediate role in environmental preservation. Further, as embodiments of the present invention continue to grow, the standard and environmentally unfriendly washer fluid jug could become a thing of the past.

While embodiments of the present invention render a “green” alternative to the environmentally unfriendly standard jug, embodiments of the present invention also render other tangible benefits. For example, its ease of use and convenience can help boost sales of windshield washer fluid. Through such increased sales, windshield washer fluid cost is decreased through bulk sales, rendering an increase in profits. Increased sales and use of embodiments of the present invention may also render increased fuel sales, if located in close proximity to an automotive fueling station. Further, valuable shelf space inside an automotive fueling station or convenience store will be freed up for additional merchandise to sell.

Methods and system claims of the above are also disclosed. Other embodiments, and other features and objects of the present invention will be in part apparent to those skilled in the art and in part pointed out hereinafter.

### BRIEF DESCRIPTION OF THE DRAWINGS

Embodiments of the invention are illustrated by way of example, and not by way of limitation, in the figures of the accompanying drawings and in which like reference numerals refer to similar elements, wherein:

FIG. 1 is an environmental view of an embodiment of the present invention in use as described herein.

FIG. 2 is a perspective view of an embodiment of the invention.

FIG. 3 is a close-up front view of an embodiment of the invention.

FIG. 4 is a rear view of an embodiment of the present invention.

FIG. 5 is a close-up view of a programmable logic circuit as utilized in an embodiment of the present invention.

FIG. 6 is a close-up perspective view of a decorative figure housing an antenna, as utilized in an embodiment of the present invention.

### DETAILED DESCRIPTION OF PREFERRED EMBODIMENTS

In the following description, for the purposes of explanation, specific details are set forth in order to provide a thorough understanding of the invention. However, it will be apparent that the invention may be practiced without these specific details. In other instances, well-known structures and devices may be depicted in block diagram form or simplified form in order to avoid unnecessary obscuring of the invention. Section titles and references appearing within the following paragraphs are intended for the convenience of the reader and should not be interpreted to restrict the scope of the information presented at any given location. As such, various aspects and features of example embodiments of the invention are described in more detail hereinafter in the following sections.

### Operation

In preferred embodiments, the windshield washer fluid dispenser is a self-contained pumping unit designed for stand-alone use. Such embodiments are designed to be utilized by users on two different levels. First, a customer must be uses this machine to transfer windshield washer fluid from inside a fluid container within the machine into their vehicle's windshield washer fluid reservoir. Second, an owner or maintenance person must be able to replace either the fluid or the replaceable fluid drum, access the built-in electronics to check machine status and if necessary, configure the machine's functionality.

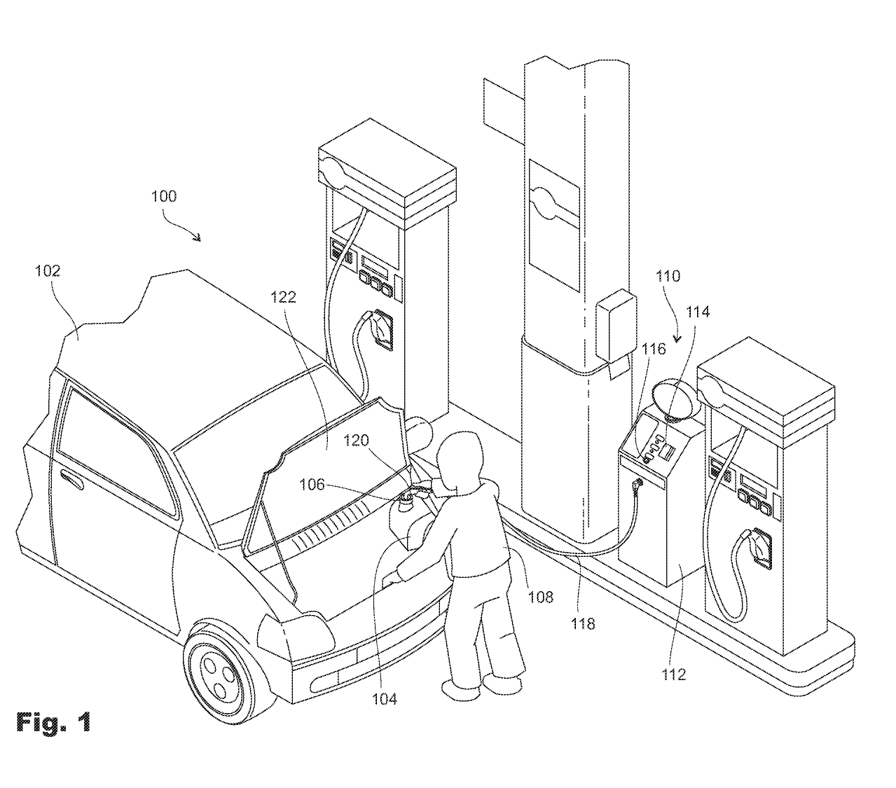

FIG. 1 illustrates an environmental view of an embodiment of the present invention, namely the refilling of windshield washer fluid into a vehicle. More particularly, a user 108 parks a vehicle 102 at a fuel station refilling station 100 and prepares the car for refilling of its windshield washer fluid, namely raising a hood 122 of the vehicle 102. Observing the instructions (not shown) on a windshield washer fluid dispenser 110, the user 108 verifies their credentials to use the device, such as paying for the purchase of the fluid via a card reader 114. In other embodiments, the user 108 can place a sufficient quantity of currency or coins (not shown) into a money receptacle (not shown), wherein the currency or coins confirm sufficient money has been collected and thereby provide credentials for the user 108 to use the dispenser 110.

In yet other embodiments, a proximity device (not shown) can be used, such as an RFID (radio frequency identification device) or other proximity device, to verify that a user 108 possesses credentials to utilize the dispenser 110. Similarly, in other embodiments, a specific analog or digital radio signal (not shown) can be used to verify credentials of a user 108, such as, but not limited to, a specific identification emitted from a wireless telephone (not shown) or other radio device (not shown).

Once credentials for use of the dispenser 110 have been verified, the user 108 then presses a start button 116 and fills a windshield washer fluid reservoir 104 of the vehicle 102 with windshield washer fluid (not shown). More particularly, the windshield washer fluid (not shown) travels from within the confines of a chassis 112 of the dispenser 110 via a hose 118 through a nozzle 120 and into the reservoir 104 through a refilling receptacle 106 of the reservoir 104.

In various preferred embodiments, the card reader 114 can be any conventional means of identification of the user or customer, such as electronic, magnetic, optical, audible, visual or biological methods of identification. Presently, various conventional methods are available for such credentials or payment, including the swiping of an acceptable personnel card, credit card, debit card or other identification reader located on the front of the device. Via a cellular modem (or other user authentication device) located inside the device, (not shown), such an identification or credit card is processed and immediately a transaction is authorized for a predetermined amount of usage. Typically, it is advantageous to configure such a device to monitor time expended since the push of the start button 116, rather than volume of the fluid dispensed since the start button 116 was pushed.

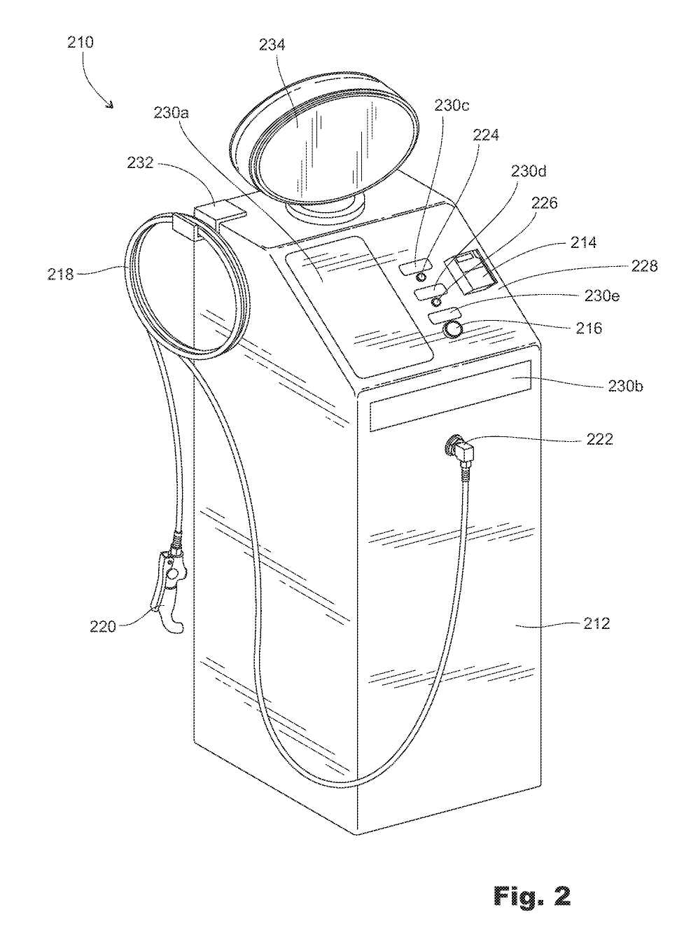

Turning to FIG. 2, a closer perspective view of a windshield washer fluid dispenser 210 is illustrated. More particularly, the windshield washer dispenser 210 incorporates similar items recited in FIG. 1, namely a chassis 212, a card reader 214, a start button 216, a hose 218, a nozzle 220. Upon a dashboard 228 located on the outside of the chassis 212, it is preferable to strategically place one or more labels 230a, 230b, 230c, 230d and 230e to instruct a user (not shown) as to how to operate the dispenser 210.

It is further preferable to provide a warning light 224 to alert the user of an empty condition or malfunction of the dispenser 210, such as the dispenser 210 being out of sufficient windshield washer fluid to provide to the user. For example, if the dispenser 210 is lacking sufficient fuel to complete a transaction, the warning light 224 would be illuminated or energized to indicate that, pursuant to a label 230c, the dispenser 210 is not in a usable configuration.

Similarly, it is preferable that the dispenser 210 be configured with a ready light 226 that can illuminate once the user is capable of dispensing fluid, pursuant to the instructions on label 230d. Alternatively, this ready light 226 can have several colors (e.g. green, blue, etc.) or timings (e.g. solid light, pulsing light, pulsing fast light, etc.) to convey different messages to a user. Such examples of different messages can be the successful receipt of credentials (e.g. successful credit card swipe and verification), or that the pump is energized and that fluid is ready to be dispensed into the vehicle.

When the user dispenses fluid into their vehicle, it is further preferable to have a selectable dispensing nozzle 220, such as the conventional nozzle 220 shown in the figure. As noted earlier, fluid originates from within the chassis 212 and passes through the hose 218 to the desired location on the vehicle. In preferred embodiments, it is more reliable to use conventional plumbing fixtures such as a plumbing elbow 222 to prevent excessive wear and tear of the hose 218. While the present illustration exemplifies a common plumbing fixture such as an elbow, any conventional plumbing configuration is possible to afford protection to the hose 218. It is further preferable to configure a bracket 232 or other means to store the hose 218 on the chassis 212, rather than leaving the hose 218 vulnerable to abrasion, elements or damage incurred on the ground.

In preferred embodiments, a decorative fixture 334 can be included for both aesthetic reasons, as well as a means to afford protection to an internal cellular antenna (not shown).

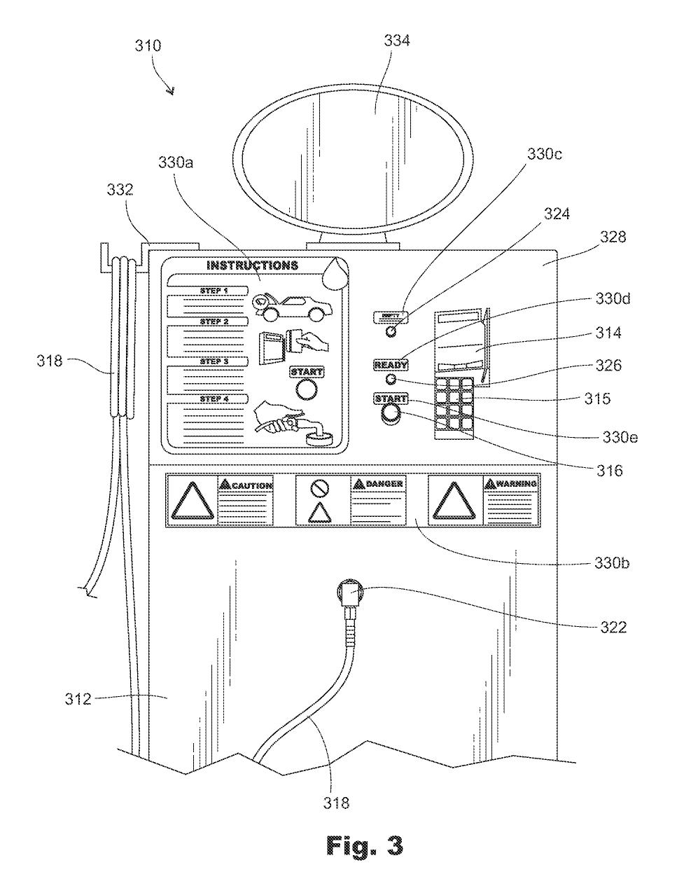

Turning to FIG. 3, a closer view of a dashboard 328 on a chassis 312 of a dispenser 310 is shown. Again, many of the recited items from previous figures are illustrated, namely a card reader 314, a start button 316, a hose 318, an elbow 322, a warning light 324, a ready button 326, one or more labels 330a, 330b, 330c, 330d and 330e, a bracket 332 and a decorative fixture 334.

More particularly, as illustrated in label 330a, a basic set of steps is presented both in visual and textual form (shown as horizontal lines), namely preparing the vehicle for dispensing, verifying credentials, pressing the start button and dispensing the fluid, as illustrated by “Step 1” through “Step 4” on label 330a. More particularly, in configurations of preferred embodiments, once the user has scanned a credit card (not shown), the user then waits for the ready light 330d to flash repeatedly, signaling the device is ready to pump fluid. Once the user is ready to begin pumping the fluid, the start button 316 is pressed, thus starting the pump (not shown) within the chassis 312 of the dispenser 310. The user would then place the nozzle (not shown) into the open receptacle (not shown) of the vehicle's washer fluid reservoir (not shown) and depress the trigger to begin the flow of fluid.

In preferred embodiments, the pump will be turned on for a designated period of time regardless of whether the nozzle trigger is depressed. However, no fluid will be pumping through the filling hose if the nozzle trigger is in its fully released position. Once the user has filled their reservoir or the device's timer has expired, the user then releases the nozzle trigger and places the filling hose back onto the designated hose hanger on the device.

Briefly returning to FIG. 1, in other preferred embodiments, it can be desirable to configure an automatic shutoff nozzle for nozzle 120 such that the nozzle 120 prevents spillage and overfilling of the reservoir 104.

While FIGS. 1-3 depict a preferred embodiment of the device configured as a basically rectangular shape, the dispenser 310 can be fabricated and configured to form practically any desired form or design, such as a cylinder shape, a wall mount, a hanging design, or practically any design that would be conducive to installation in a fuel refilling station.

It is appreciated that various embodiments implemented throughout different currencies and locations of the world can require different payment methods, such as the need for an EMV compliant device. “EMV” is a standard for interoperation of IC cards (“Chip cards”) and IC capable POS terminals and ATMs, for authenticating credit and debit card payments. The name EMV comes from the initial letters of Europay, MasterCard and VISA, the three companies which originally cooperated to develop the standard. As such, a pinpad 315 can also be configured in addition or in substitution for card reader 314. Pinpad 315 can be used such that a user can input a special code as a credential to complete the payment process or otherwise complete authorization for the dispensing of fluid.

In yet other embodiments, it can be desirable to implement RFID (radio frequency identification), physical proximity devices, radio frequency devices or other credential means. Such means can be in addition to, or substitution of, card reader 314 depending upon the application.

### Refilling, Configuration and Other Considerations

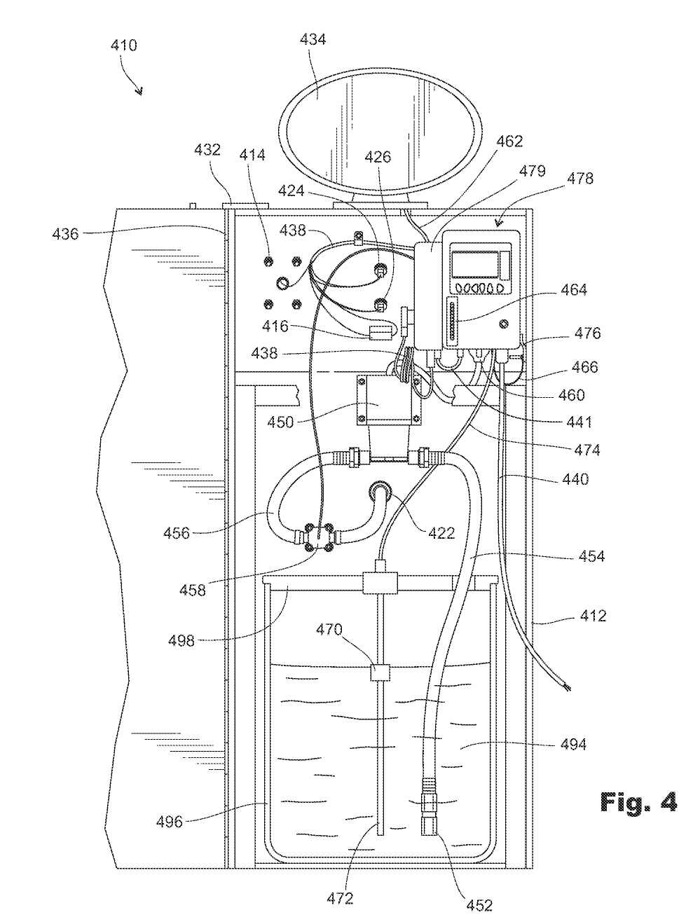

Turning to FIG. 4, a view from the rear of a windshield washer fluid dispenser 410 is shown. Again, many of the recited items from previous figures are illustrated, namely a chassis 412, a rearward portion (namely four bolts) of a card reader 414 affixed to the chassis 412, a rearward portion of a start button 416, a rearward portion of an elbow 422, a rearward portion of a warning light 424, a rearward portion of a ready button 426, a hose bracket 432 and a decorative fixture 434.

It is preferable to configure the rearward side of the chassis 412 of the dispenser 410 with a lockable door 436. Typically, a key or other securing means (e.g. padlock, keypad, etc.) is unlocked to provide access to the inside of the chassis 412 of the dispenser 410. An attendant (not shown) can therefore open the door 436 of the chassis 412, revealing additional inner components of the dispenser 412 for various needs of checking status or configuration, including: one or more connective wires 438, a power cord 440, a data cable 441, a pump 450, an inlet 452, an inlet hose 454, an outlet hose 456, a flow meter 458, a pump energizing cord 460, an antenna cord 462, a thermometer 464, a grounding wire 466, a float 470, a float switch rod 472, a float switch cord 474, a mounting fixture 476, a programmable logic circuit 478, a cellular modem 479, a drum 496, a lid 498 and a quantity of windshield washer fluid 494.

It is preferable to configure the dispenser 410 with a power source (not shown) from a conventional power grid or power generator, such as 110V alternating current in North America. The power cord 440 serves as a conduit for such power, which can come in the form of underground cabling, conventional wall wiring or overhead supply.

The pump 450 is preferably of sufficient power rating and flow rating to effect a sufficient flow of windshield washer fluid 494 from the drum 496 into a user's vehicle. In various tests, we have found that a conventional pump capable of 4 to 5 gallons per minute is sufficient, although more and less powerful pumps can be utilized. It should also be noted that other voltage systems or alternate power sources such as battery, solar panel, fuel cell or other conventional energy means can be used to power the dispenser 410 and pump 450.

Typically, the programmable logic circuit 478 controls most or all of the functions (e.g. energizing of pump, etc.), lights (e.g. warning light 424, ready light 426, etc.) and other functional components of the dispenser. For example, once a user verifies their credentials utilizing the card reader 414 and the user pushes the start button 416, the programmable logic circuit 478 energizes the pump 450 through the pump energizing cord 460 which is plugged into the programmable logic circuit 478. As a precaution and protective measure, it is preferable to ground the programmable logic circuit 478 to the chassis 412 of the dispenser 410 through a grounding wire 466.

It can also be advantageous in alternate embodiments of the present invention to omit a start button 416 and instead configure the programmable logic circuit 478 to acknowledge receipt of an electrical signal from the flow meter 458 that the dispensing of fluid has commenced. At that juncture, the programmable logic circuit 478 can also alternatively be configured to receive continued signals from the flow meter 458 indicating the total volume of fluid dispensed. Such an embodiment, thereby, reduces the need for a start button 314 and therefore is less complicated for a user to utilize. Such an embodiment also enables the dispenser to be configured, if desirable in a particular application, to dispense a specific or maximum volume of fluid.

In preferred embodiments of the present invention, the cellular modem 479 electronically communicates with the programmable logic circuit 478 and thereby performs any wireless communication functions needed by the programmable logic circuit 478 for payment or authorization of use. Typically, the modem 479 and programmable logic circuit 478 can be connected through conventional circuitry, such as the data cable 441 as illustrated.

Once the programmable logic circuit 478 energizes the pump 450, a quantity of windshield washer fluid 494 flows in the inlet 452, through the inlet hose 454, through the pump 450, into the outlet hose 456 and through the flow meter 458, again through the remaining outlet hose 456, through the elbow 422 and through the hose (not shown) to the nozzle (not shown) and into the user's vehicle windshield washer dispenser reservoir (not shown). To prevent delays of providing fluid quickly during a usage, it is preferable to configure a check valve on inlet 452, or elsewhere in the plumbing, to prevent air becoming trapped in the pump or other plumbing components of the device.

To prevent the unintended consequence of the dispenser 410 being used when there is an insufficient quantity of windshield washer fluid 494 in the drum 496, it is recommended that a conventional float switch be implemented to diagnose such a condition. A typical float switch, as illustrated, comprises of a rod 472 upon which a float 470 can slide up and down according to the depth of the quantity of windshield washer fluid 494. The position of the float 470 therefore presents a varying electrical signal through float switch cord 474 to the programmable logic circuit. Upon a condition where the float 470 is near the bottom of rod 472, the signal would indicate an “empty” quantity signal through the float switch cord 474. In response, the programmable logic circuit 478 would illuminate the warning light 424 and disable usage of the dispenser 410.

The one or more connective wires 438 can be of conventional wiring and electrical conduit and switches to accommodate the various demands of the internal components, such as supplying power, communication signal or other needs for a respective component to function.

Various conventional drums or other containers can be used, (e.g. 15-55 gallon drums) as a drum 496, constructed preferably of non-corroding materials such as plastic. The drum 496 can be constructed with a lid 498 incorporated into the drum 496 or as a separate lid 498 as shown in the figure.

To replace the drum 496, the attendant pulls the inlet hose 454 and float switch rod 472 out of the drum 496, and removes the lid 498 if necessary. The drum 496 is then removed from the dispenser 410. Preferably using a hand cart, the attendant gently places a new drum (e.g. full of fluid, not shown) into the dispenser 410. The inlet hose 454 and float sensor rod 472 are replaced directly into the new drum. The access door 436 is closed and the chassis 412 is re-secured with a lock (not shown) or other securing means.

In alternate embodiments of the invention, it can be advantageous to utilize compressed air in environmental communication with fluid 494, thereby relieving the need for a pump 450 to move fluid 494 throughout the various plumbing. Similarly, designs incorporating gravity as a force for fluid movement can be implemented whereby drum 496 is elevated and the embodiment similarly can be operated without a pump 450 being configured in the embodiment. Similarly, other embodiments can utilize either compressed air or a vacuum to provide the force necessary to move fluid 494 through the dispenser.

In order to provide for a more reliable communications means for verifying credentials, it is helpful to utilize an external antenna (not shown) within the decorative fixture 436, which is further detailed in the following sections.

### Programmable Logic Circuit

Preferably, embodiments of the present invention can also be configured in custom ways to conform to the intended consumer base, such as timing, functionality and other configurable features. Once the rear access door of the windshield washer fluid dispenser is opened, various configurations can be effected by an attendant (not shown) by configuring the programmable logic circuit 578.

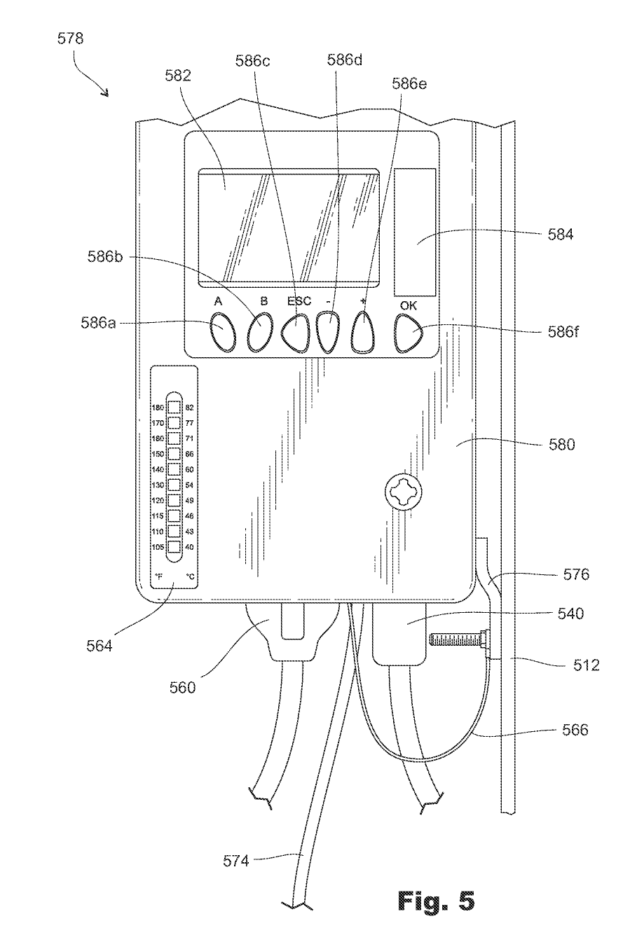

Turning to FIG. 5, a portion of a programming logic circuit 578 is illustrated. Many of the recited items from previous figures are also shown, namely a chassis 512, a power cord 540, a pump energizing cord 560, a thermometer 564, a grounding wire 566, a float switch cord 574. More particularly, several controls such as a viewing screen 582 and one or more buttons 586a through 586f are available on the faceplate 580 of such a programmable logic circuit 578. The principle function of the screen 582 and buttons 586a through 586f are to control various features of the windshield washer dispenser vis a vis the programmable logic circuit 578.

As with conventional graphic displays such as the screen 582, menus of options or specific views of information can be presented to a user. Typically, an attendant can press a first “A” button 586a to scroll through various available menus or views and press a second “B” button 586b to return to an earlier menu or view upon the screen 582.

It is also preferable to have an escape button 586c to return to a primary menu or view, or proceed backwards in a certain process of steps. Typically, buttons “−” and “+”, respectively buttons 586d and 586e, allow the user to edit configurable values such as the amount of time for a given transaction, or the amount of currency tendered to commence a transaction. An “OK” button 586f is also preferable to have on the programmable logic circuit 578 to provide a user an easy means to accept a given value or move forward within a menu or view on the screen 582.

It is preferable that one or more views, at a minimum, display information relating to the software version, date, current sale value and countdown timer of the device. It is further preferable that one or more screens display information relating to the total accumulated currency accepted (e.g. U.S. dollars), total accumulated dispensing time, and total accumulated gallons/liters dispensed. Further screens and configurations are desirable which can configure the gallons/liters per minute, time allotted per monetary unit, transaction timeout periods, and related features.

In certain embodiments, it can be desirable to have a manual override to allow manual operation of the pump or device, such as those bulk dispensing circumstances relating to attendant filling, large reservoir tanks, bulk sales etc.

Embodiments of the present invention can be typically manufactured from readily available components, depending upon the application sought. A typical, preferred embodiment of the present invention is comprised of a chassis, an electrical processor with controls, and an array of plumbing parts.

More particularly the chassis 512 of embodiments of the present invention can be manufactured from 16 gauge metal housing. The chassis 512 typically houses or serves as a structure to couple the remaining components.

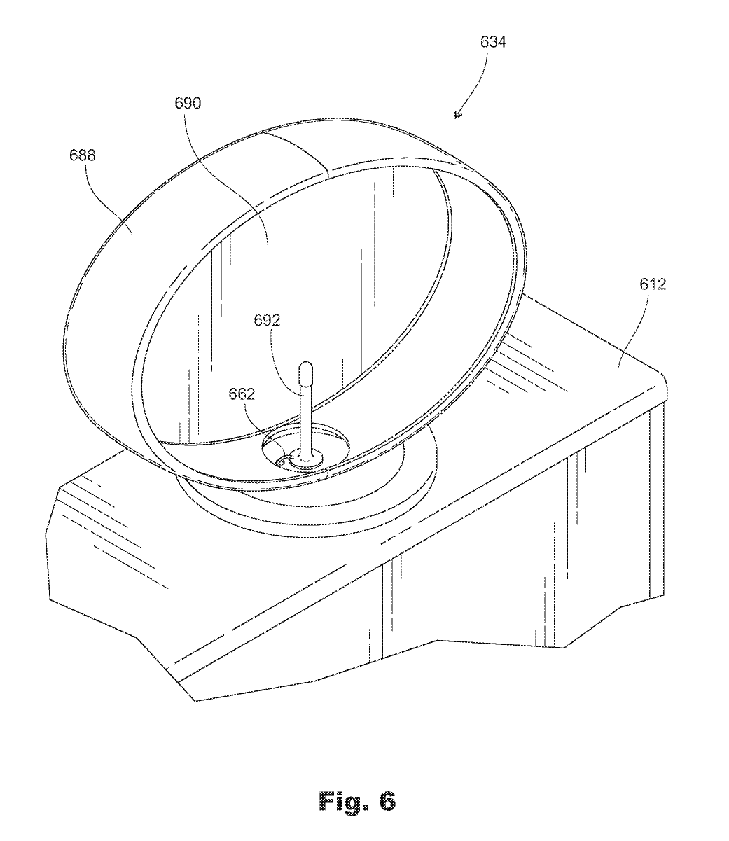

Turning to FIG. 6, a decorative fixture 634 mounted upon a chassis 612 is illustrated. As an external antenna 692 typically provides superior clarity and reception for wireless communications signals, it is preferable to configure such an antenna 692 at the top of the chassis 612 of a windshield washer fluid dispenser. It is further preferable that such an antenna 692 be protected from environmental conditions (e.g. rain, wind, etc.) and other possible forms of damages such as unintentional contact with people or items. In that regard, a decorative fixture 634 as shown provides such protection from the elements and hazardous conditions where a windshield washer fluid dispenser is typically installed. The antenna 692 can be in electrical coupling with the cellular modem (not shown) with an antenna cord 662 as shown.

The decorative fixture 634 can comprise of one or more panels 690, whether translucent or opaque, which is secured and circumferentially connected to the chassis 512 by a rim 688 as shown. The decorative fixture 634 can be illuminated or not illuminated, and can be constructed from a variety of materials including glass, metal, plastic or other materials depending upon the application, desired level of protection and aesthetic needs.

### Safety Considerations

Embodiments of the present invention are typically a stand-alone unit that has been designed to be placed anywhere standard electricity (e.g. 110 volts alternating current) is present. Embodiments have been tested and found to comply with UL Standard 751 and CSA Standard C22.2 No. 128 by Intertek Testing Services North America, Inc., although such certification is not critical to the novelty or usefulness of the presently disclosed embodiments.

There are several safety factors that should be incorporated in order to operate embodiments of the washer fluid dispenser safely. For example, standard 20 degree Fahrenheit washer fluid is flammable. The site of embodiments of the present invention should be free of smoking, fire or sparks. If a desired permanent mounting location is in close proximity to an automotive fueling station (or other fueling station), then embodiments of the present invention should be placed a minimum of 20″ away from any gas pump assembly. Containers other than automobile washer fluid reservoirs should be placed on ground before filling to avoid static electricity. If windshield washer fluid is introduced internally, it can cause blindness, internal damage, or death. If swallowed, contact a poison control professional or a physician immediately. Avoid lengthy exposure to washer fluid fumes as they can be harmful. Fluid dispensed from embodiments of the present invention should be directed into the washer fluid reservoir to avoid spills and overfilling. Fluid from embodiments of the present invention should never be dispensed directly onto vehicle's windshield from dispensing hose. Electrical installation of embodiments of the present invention should be performed by a licensed, certified electrician.

Further, it is preferable that embodiments do not cause harmful radio interference, and must accept any interference received, including interference that may cause undesired operation, (such as compliances with U.S. FCC Part A or Canadian Canadian ICES-003).

To prevent unintended movement and interruptions of service, it is recommended that embodiments of the present invention be permanently affixed to a level and flat surface, preferably constructed of concrete or asphalt.

Embodiments of the present invention are to be preferably serviced from time to time to ensure proper functionality, notwithstanding that the device should be checked regularly to make sure there is an adequate supply of fluid. All plumbing connections should be inspected regularly to make sure no leaks have formed. One preferably inspects the status of all lights, readouts, and switches for cracks or malfunctions on a regular basis. It is also advisable to periodically wipe down the exterior as needed to extend the life of the exterior chassis.

### Alternate Embodiments

There are numerous and diverse additional embodiments anticipated by the present invention, as further summarized below. It is understood that the apparatus and methods discussed herein provide a means for dispensing a consumable fluid, but are not restricted to the preferred embodiment of windshield washer fluid. Therefore, it is further understood that the following examples are not limiting by nature, but rather alternate specific examples where the disclosed apparatus and method can be utilized.

Embodiments of the present invention can be used in commercial trucking, and more particularly to provide windshield washer fluid to commercial vehicles through a cardkey or other authentication system (e.g. United Parcel Service, Federal Express, etc.). Likewise, embodiments are well-suited for certain military purposes, namely the dispensing of windshield washer fluid or other fluids as necessary for military vehicles.

In other fields of transportation, embodiments of the present invention are also suited for rail or air transportation services, as the dispensing method provided herein can be used at attended or non-attended stations.

Embodiments of the present invention are also well suited to a vast number of additional retail, temporary accommodations and residential applications. For example, retail, hotel or residential application can include the storage and dispensing of re-saleable liquids, cleaner or other liquids. Such a fluid dispenser can also be used in retail, wholesale or internal uses for dispensing of fertilizer, maple syrup, wax, oil or practically any fluid that is placed into a container to serve a purpose. Other such embodiments, without limitation, can incorporate refrigeration or heating means, or other means which provide environmental conditions suitable for the given fluid to be dispensed.

### Conclusion

The novel and useful approaches described herein for providing windshield washer fluid or other fluids evidence a variety of benefits over prior art approaches. In particular, embodiments of the present invention provide one or more additional aspects of enhanced convenience, usability and reliability over the prior art.

Preferred embodiments of this invention are described herein, including the best mode known to the inventors for carrying out the invention. As can be appreciated from the technical disclosure herein, embodiments of the present invention evidence a variety of advances and benefits over the prior art, uniquely and advantageously yielding savings of time, effort, and cost relative to the existing prior art currently utilized. Of course, variations on those preferred embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

The terms “a” and “an” and “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided herein is intended merely to better illuminate the invention and does not pose a limitation on the scope of the invention otherwise claimed. No language in the specification should be construed as indicating any non-claimed element essential to the practice of the invention. Groupings of alternative elements or embodiments of the invention disclosed herein are not to be construed as limitations. Each group member may be referred to and claimed individually or in any combination with other members of the group or other elements found herein.

Furthermore, if any references have been made to patents and printed publications in this specification, then each of the above cited references and printed publications, if any, are herein individually incorporated by reference in their entirety.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

The invention claimed is:

1. An improved windshield washer fluid dispenser for selectively filling a vehicle windshield washer fluid reservoir, comprising:
a chassis with an interior space defined by the chassis;
an access door to access the interior space of the chassis, wherein the access door can be selectively locked;
a power source capable of rendering electric power to operate the dispenser;
a removable drum within the interior space, the drum being capable of containing a quantity of windshield washer fluid;
a pump, a one or more plumbing fixtures, a hose and a selectable nozzle to selectively dispense the contents of the fluid container;
a means for verifying credentials for use of the windshield washer fluid dispenser;
a ready light to alert a user that the windshield washer dispenser is in a condition ready for usage;
a programmable logic circuit which energizes the pump, which in turn pumps a portion of the quantity of fluid to be dispensed from the windshield washer fluid dispenser into the reservoir through the hose and the selectable nozzle; and,
wherein the programmable logic circuit further provides configurable functions with respect to the ready light, the card reader, the pump and the valve.

2. The improved windshield washer fluid dispenser of claim 1, wherein the means for verifying credentials for use of the windshield washer fluid dispenser is a money receptacle.

3. The improved windshield washer fluid dispenser of claim 1, wherein the means for verifying credentials for use of the windshield washer fluid dispenser is a proximity device.

4. The improved windshield washer fluid dispenser of claim 1, wherein the means for verifying credentials for use of the windshield washer fluid dispenser utilizes a radio signal.

5. The improved windshield washer fluid dispenser of claim 1, wherein the means for verifying credentials for use of the windshield washer fluid dispenser utilizes a wireless telephone.

6. The improved windshield washer fluid dispenser of claim 1, wherein the means for verifying credentials for use of the windshield washer fluid dispenser is a card reader.

7. The improved windshield washer fluid dispenser of claim 6, further comprising a cellular modem providing wireless transmission capabilities for the card reader to verify credentials for use of the windshield washer fluid dispenser.

8. The improved windshield washer fluid dispenser of claim 6, further comprising a start button that communicates with the programmable logic circuit for delaying the commencement of the dispensing of a quantity of windshield washer fluid.

9. The improved windshield washer fluid dispenser of claim 6, further comprising a float switch to determine whether an empty condition exists with respect to the quantity of windshield washer fluid within the drum.

10. The improved windshield washer fluid dispenser of claim 6, further comprising a warning light to alert a user of an empty condition and thereby prevent unintentional use of the windshield washer dispenser;

11. The improved windshield washer fluid dispenser of claim 6, further comprising a fluid check valve to prevent unintentional delay in dispensing a quantity of windshield washer fluid.

12. The improved windshield washer fluid dispenser of claim 6, wherein the pump utilizes compressed air or a vacuum to selectively dispense a quantity of the contents of the fluid.

13. The improved windshield washer fluid dispenser of claim 6, further comprising a flow meter capable of determining that the dispensing of fluid has commenced.

14. The improved windshield washer fluid dispenser of claim 13, wherein the dispensing of fluid is limited by a specific expiration of time after the flow meter determines that the dispensing of fluid has commenced.

15. The improved windshield washer fluid dispenser of claim 13, wherein the flow meter can measure the volume of fluid dispensed and the dispensing of fluid is limited by a specific limit of volume of fluid dispensed.

16. A method for dispensing windshield washer fluid, comprising the steps of:
providing a windshield washer fluid dispenser having a quantity of windshield washer fluid;
observing a ready light on a windshield washer fluid dispenser;
observing absence of a warning light on the windshield washer fluid dispenser;
providing credentials for a transaction via a means for verifying credentials;
pushing a start button to commence a pump from within the windshield washer fluid dispenser; and,
dispensing a quantity of windshield washer fluid from the windshield washer fluid dispenser.

17. The method for dispensing windshield washer fluid of claim 13, wherein the step of providing credentials utilizes a card reader, and the step of dispensing of a quantity of windshield washer fluid is limited by a specific limit of volume of fluid dispensed.

18. An improved windshield washer fluid dispenser for selectively filling a vehicle windshield washer fluid reservoir, comprising:
a chassis with an interior space defined by the chassis;
an access door to access the interior space of the chassis, wherein the access door can be selectively locked;
a power source capable of rendering electric power to operate the dispenser;
a removable drum within the interior space, the drum having a lid and being capable of containing a quantity of windshield washer fluid;
a pump, a one or more plumbing fixtures, a hose and a selectable nozzle to selectively dispense the contents of the fluid container;
a fluid check valve to prevent unintentional delay in dispensing a quantity of windshield washer fluid;
a card reader for verifying credentials for use of the windshield washer fluid dispenser;
a cellular modem providing wireless transmission capabilities for the card reader to verify credentials for use;
a float switch to determine whether an empty fluid condition exists with respect to the quantity of windshield washer fluid within the drum;
a ready light to alert a user that the windshield washer dispenser is in a condition ready for usage;
a warning light to alert a user of an empty fluid condition and thereby prevent unintentional use of the windshield washer dispenser;
a start button for commencing the operation of the windshield washer fluid dispenser which communicates a signal to a programmable logic circuit, which in turn energizes a pump, which in turn pumps for a portion of the quantity of fluid to be dispensed from the windshield washer fluid dispenser into the reservoir through a filler hose with a selectable nozzle;
a flow meter capable of determining that the dispensing of fluid has commenced; and,
wherein the programmable logic circuit further provides configurable functions with respect to the warning light, the ready light, the start button, the card reader, the pump and one or more limitations of usage of the dispenser.

19. The improved windshield washer fluid dispenser of claim 18, wherein the dispensing of fluid is limited by a specific expiration of time after the flow meter determines that the dispensing of fluid has commenced.

20. The improved windshield washer fluid dispenser of claim 18, wherein the flow meter can measure the volume of fluid dispensed and the dispensing of fluid is limited by a specific limit of volume of fluid dispensed.
